(19) United States
(12) Patent Application Publication
(10) Pub. No.: US 2024/0181574 A1
(43) Pub. Date: Jun. 6, 2024

(54) SYSTEMS AND METHODS FOR PREDICTING PART DEFECTS DURING ADDITIVE MANUFACTURING

(71) Applicant: VulcanForms Inc., Burlington, MA (US)

(72) Inventors: Dayu Huang, Belmont, MA (US); Yiqun Xue, Belmont, MA (US); Alexander Dunbar, Watertown, MA (US); Sheikh Rufsan Reza, Houston, TX (US); Nicholas T. Dee, Cambridge, MA (US)

(73) Assignee: VulcanForms Inc., Burlington, MA (US)

(21) Appl. No.: 18/524,219

(22) Filed: Nov. 30, 2023

Related U.S. Application Data
(60) Provisional application No. 63/429,231, filed on Dec. 1, 2022.

(51) Int. Cl. B23K 31/12; B23K 26/342; G06T 7/00

(52) U.S. Cl. CPC B23K 31/125; B23K 26/342; G06T 7/0008; B33Y 30/00; G06T 2207/20024; G06T 2207/20081

(57) ABSTRACT

Systems and methods for predicting weld and/or part defects during additive manufacturing process are disclosed. Additionally, systems and methods related to controlling an additive manufacturing process using predicted weld and/or build defects are disclosed.

### RELATED APPLICATIONS

This application claims priority under 35 U.S.C. § 119(e) to U.S. Provisional Application No. 63/429,231, filed Dec. 1, 2022, the content of which is incorporated by reference in its entirety for all purposes.

### FIELD

Disclosed embodiments are generally related to systems and methods for predicting part defects during additive manufacturing.

### BACKGROUND

Additive manufacturing systems employ various techniques to create three-dimensional objects from two-dimensional layers. After a layer of precursor material is deposited onto a build surface, a portion of the layer may be fused through exposure to one or more energy sources to create a desired two-dimensional geometry of solidified material within the layer. Next, the build surface may be indexed, and another layer of precursor material may be deposited. For example, in conventional systems, the build surface may be indexed downwardly by a distance corresponding to a thickness of a layer. This process may be repeated layer-by-layer to fuse many two-dimensional layers into a three-dimensional object. Oftentimes, defects may occur during printing of a part which may result either in the part being rejected after printing and/or may result in a halt of a printing process if a severe enough defect is detected.

### SUMMARY

In some embodiments, an additive manufacturing system comprises a build surface, one or more laser energy sources, an optics assembly configured to direct laser energy from the one or more laser energy sources toward the build surface to melt at least a portion of a layer of material disposed on the build surface to form one or more welds, and one or more light sources configured to illuminate the build surface. The one or more light sources are configured to emit light in a direction that is at least partially parallel to the build surface. The additive manufacturing system further comprises a photosensitive detector configured to image at least a portion of the build surface and a processor. The processor is configured to perform the steps of imaging at least a portion of the build surface with the photosensitive detector, subdividing at least a portion of the image corresponding to the location of at least one part in the build surface into a plurality of regions, and identifying the presence of weld defects in the build surface based at least in part on light intensities of the plurality of regions.

In some embodiments, a method of detecting weld defects in a build surface of an additive manufacturing system comprises obtaining an image of at least a portion of the build surface, subdividing at least a portion of the image corresponding to a location of a part in the build surface into a plurality of regions, and identifying the presence of weld defects in the build surface based at least in part on light intensities of the plurality of regions.

In some embodiments, an additive manufacturing system comprises a build surface, one or more laser energy sources, an optics assembly configured to direct laser energy from the one or more laser energy sources toward the build surface to melt at least a portion of a layer of material disposed on the build surface to form one or more welds, a photosensitive detector configured to image at least a portion of the build surface, and a processor. The processor is configured to perform the steps of providing information related to the presence of weld defects in one or more sequential layers of one or more parts to a trained weld-based defect prediction statistical model and predicting formation of part defects in the one or more parts using the trained weld-based defect prediction statistical model.

In some embodiments, a method of predicting formation of part defects in one or more parts formed with an additive manufacturing system comprises providing information related to the presence of weld defects in one or more sequential layers of the one or more parts to a trained weld-based defect prediction statistical model and predicting the presence of part defects in the one or more parts using the trained weld-based defect prediction statistical model.

In some embodiments, a method for training a weld-based defect prediction statistical model comprises obtaining training data. The training data includes weld defect data and part defect data associated with a plurality of sequential layers of a plurality of separate parts formed with an additive manufacturing system. The method further comprises generating a trained weld-based defect prediction statistical model using the training data and storing the trained statistical model on non-transitory computer readable memory for subsequent use.

In some embodiments, an additive manufacturing system comprises a build surface, one or more laser energy sources, an optics assembly configured to direct laser energy from the one or more laser energy sources toward the build surface to melt at least a portion of a layer of material disposed on the build surface to form one or more welds, a photosensitive detector configured to image at least a portion of the build surface, and a processor. The processor is configured to perform the steps of obtaining one or more images of the build surface with the photosensitive detector after fusing the material in one or more sequential layers during formation of one or more parts, obtaining one or more process parameters associated with formation of the one or more sequential layers, providing the one or more images and the one or more process parameters to a trained multivariate defect prediction statistical model, and predicting the formation of part defects in the one or more parts using the trained multivariate defect prediction statistical model.

In some embodiments, a method of predicting formation of part defects in one or more parts formed with an additive manufacturing system comprises obtaining one or more images of a build surface after fusing material in one or more sequential layers during formation of the one or more parts, obtaining one or more process parameters associated with formation of the one or more sequential layers of the one or more parts, providing the one or more images and the one or more process parameters to a trained multivariate defect prediction statistical model, and predicting the formation of part defects in the one or more parts using the trained multivariate defect prediction statistical model.

In some embodiments, a method for training a multivariate defect prediction statistical model comprises obtaining training data, wherein the training data includes predicted part defect data determined based at least in part on weld quality for a plurality of parts, process parameter data associated with formation of a plurality of sequential layers of the plurality of parts, and images of a build surface of an additive manufacturing system after fusing material of the plurality of sequential layers for the plurality of parts. The method further comprises generating a trained multivariate statistical model using the training data and storing the trained multivariate statistical model on non-transitory computer readable memory for subsequent use.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a schematic representation of an additive manufacturing system according to some embodiments;

FIG. 2 shows an additive manufacturing system according to some embodiments;

FIG. 3 shows an arrangement of one or more light sources and a build surface according to some embodiments;

FIG. 4A shows a side view of a build surface containing a weld;

FIG. 4B shows a light and a cross-section view of a build surface containing a weld according to the embodiment of FIG. 4A;

FIG. 4C shows a light and a top view of a build surface containing a weld according to the embodiments of FIGS. 4A and 4B;

FIG. 5A shows a side view of a build surface containing a weld according to some embodiments;

FIG. 5B shows a light and a top view of the build surface of the embodiment shown in FIG. 4D containing a weld with defects;

FIG. 6A shows an image of a weld line with directions of corresponding gradients shown as arrows;

FIG. 6B shows an image of a weld line containing a defect with directions of corresponding gradients shown as arrows;

FIG. 7 shows a part on a build surface subdivided into regions indicating scores for each region corresponding to weld quality;

FIG. 8 is a schematic diagram of one embodiment of a method for creating a local region score map and using the local region score map to control a build process;

FIG. 9 is a schematic diagram of one embodiment of a method for training a weld-based defect prediction statistical model;

FIG. 10 is a schematic diagram of one embodiment of a method for using a weld-based defect prediction statistical model;

FIG. 11 is a schematic diagram of one embodiment of a method for training a multivariate defect prediction statistical model;

FIG. 12 is a schematic diagram of one embodiment of a method for using a multivariate defect prediction statistical model; and

FIG. 13 presents a schematic representation of one embodiment of a computing device that may be configured to implement any of the methods disclosed herein.

### DETAILED DESCRIPTION

Additive manufacturing processes may produce a variety of defects during a build process which may render a part defective depending on the severity and/or location of the defects. Defective parts may be discarded as waste, resulting in unnecessary use of material, additive manufacturing system printing capacity, and/or user time. In typical additive manufacturing systems, operators may manually determine the presence of defects and may manually stop a build process and/or adjust process parameters associated with the build process in an effort to either mitigate or prevent the occurrence of a part defect. However, manually determining the presence of weld defects and/or part defects may be costly and burdensome in addition to being very dependent on the skill of an operator. Additionally, the use of typical weld quality monitoring systems and/or methods may be cost prohibitive and present burdensome processing requirements as the area of build surfaces increase. Thus, the Inventors have recognized the benefits associated with computationally efficient and robust methods for identifying and/or predicting various types of defects during a build process. This information may then be used to either help mitigate defects and/or other control process may be implemented by an additive manufacturing system to help reduce unnecessary use of material, time, and/or other expenditures.

In addition to the above, the Inventors have also recognized that identifying and/or predicting the presence of weld and/or part defects may be complicated by the large number of welds formed during a print process as well as the many different types of defects that may be formed during a print process. For example, one type of weld defect which may occur during a build process of an additive manufacturing system is a balling defect. When building parts using powder bed fusion, balling defects may occur in areas of low input energy density. Balling defects can occur when a gap forms in a track of melted material, and a ball or sphere shaped melt pool forms. These misshapen melt pools may result in undesired gaps or deformities in the weld. However, other types of defects may occur including, but not limited to, short feeds (e.g., where a layer of recoated material does not sufficiently cover a layer of previously fused material), weld pattern disruptions, unfused areas, and/or any appropriate type of defect associated with a weld may be present in a build layer which may result in a corresponding part defect in the final part. In either case, the Inventors have recognized that in some instances the gaps or deformities in the welds formed in a build layer may result in one or more discontinuities along a length of the corresponding welds. These discontinuities may result in observable effects during imaging that may be used to identify weld defects in a build layer and/or predict the formation of part defects in a part as elaborated on further below.

In view of the above, it may be desirable to identify the presence of weld defects in the one or more build layers. For example, this determination may be based at least in part on information contained in images of a build surface including fused precursor material corresponding to the one or more build layers of one or more parts. The portions of the build surface including fused precursor material may correspond to the location of a plurality of welds formed in the build surface. As noted above, weld defects included in these plurality of welds may result in observable discontinuities. Specifically, when illuminated by one or more light sources the reflected or otherwise scattered light may change in an observable way relative to the weld defects as compared to other continuous portions of the welds. For example, in some embodiments, a gradient of the light intensity may be different for weld defects as compared to the other continuous portions of the welds. Thus, as elaborated on further below, the one or more images may be subdivided into a plurality of regions corresponding to the locations of the one or more parts contained in the layer. The weld defects may then be identified based at least in part on the observed light intensities within those plurality of regions. In some such embodiments, information related to light intensity gradients relative to the different portions of the weld relative to a fusion direction of the welds may be used to identify weld defects. Once the presence of weld defects in the one or more build layers has been identified, this information may either be output to a user and/or used for controlling one or more aspects of a build process of the one or more parts.

In some embodiments, the presence of weld defects in the above noted regions may be identified based on values determined using the above noted method that are representative of a quality of the welds included in the different regions. For example, each region of a part on a build surface may be assigned a value corresponding to the weld quality of that region. In some embodiments, the values of each region may be normalized. The normalized values may serve as scores representing the weld quality of the regions, though the use of values that are not normalized are also contemplated. Weld defects may be identified in some embodiments by comparing these scores of the different regions to one or more thresholds (e.g., a normal weld threshold, minor weld defect threshold, major weld defect threshold, etc.) where if a score is less than the one or more thresholds that region may be considered to include one or more weld defects.

The Inventors have also recognized that statistical models may be used to help predict the formation of part defects in one or more parts being formed (e.g., voids, unfused portions of a precursor material, and/or any other appropriate type of part defect that may be formed during an additive manufacturing process). Further, given the difficulty in obtaining appropriate types and quantities of training data for such a model, the Inventors have recognized that the above disclosed weld defect identification algorithm may help facilitate the training and use of such a statistical model in some embodiments. Specifically, a weld defect identification algorithm may permit the location of weld defects, and thus corresponding potential part defects, to be easily identified for subsequent analysis. Thus, training data sets may more easily be obtained as detailed further below, though the use of manually obtained training data either by itself and/or in combination with the above is also contemplated.

In some embodiments, a trained statistical model may be configured to predict the formation of part defects based on information related to the presence of weld defects in one or more parts. The trained statistical model may be referred to as a weld-based defect prediction statistical model. In such an embodiment, information related to the presence of weld defects in one or more sequential build layers of a part may be obtained. In some instances, the weld defect information may be related to a plurality of build layers (e.g., 2 or more, 3 or more, etc.). This may include obtaining images of at least a portion of a build surface of an additive manufacturing system after a layer of precursor material has been at least partially fused to form the one or more parts thereon. The presence of weld defects within those images may then be determined as described elsewhere herein and/or using any other appropriate weld defect identification method or system. For example, in some embodiments, the information may be provided as a map of the build surface including a plurality of regions with different scores related to a quality of the welds in the different regions associated with the one or more parts. Once the information related to the presence of weld defects is obtained, the information may be provided to the trained weld-based defect prediction statistical model. The trained statistical model may then predict the formation of part defects in the one or more parts based at least in part on the provided weld defect information. An output from the statistical model may include a location, and optionally a type and/or severity (e.g. size, severity classification, etc.), of the predicted part defects relative to the one or more parts.

While the Inventors have recognized that it may be desirable to provide a trained statistical model to predict the formation of part defects using images and process parameters of a build process, large volumes of labeled data may be needed to train such a model. However, obtaining these large volumes of labeled data can be challenging given the large number of possible variations associated with images and process parameters. For example, as elaborated on further below, the use of characterization techniques such as computed tomography scans, microscopic examination, visual inspection, cross-sectioning, and/or other typical methods may be both expensive and time consuming such that it may be difficult to obtain a desired amount of training data. However, the above-noted weld-based defect prediction statistical model may be used to provide a desired amount of training data based on any number of parts that are produced on an additive manufacturing system. That said, the use of manually obtained training data either by itself or in combination with the use of predicted part defect data may also be used.

In view of the above, in some embodiments, a statistical model may be configured to predict the formation of part defects based at least in part on one or more process parameters associated with a build process and one or more images of a build surface including one or more fused portions of a layer of precursor material disposed thereon corresponding to a build layer of the one or more parts. The images and process parameters may be obtained using real-time sensing of the images and process parameters, a specific process parameter being commanded, the images and/or process parameters being recalled from associated memory, and/or any other appropriate manner of obtaining the desired information. Due to the prediction being based on multiple types of information (e.g., the one or more images and the one or more process parameters), in some embodiments, the statistical model may be a multivariate statistical model and may be referred to herein as a multivariate defect prediction statistical model. Once the desired images and process parameters are obtained, the one or more images and process parameters may be input into the trained multivariate defect prediction statistical model. The one or more images and the process parameters may then be used at least in part by the trained multivariate defect prediction statistical model to predict the formation of part defects in the one or more parts. An output from the statistical model may include a location, and optionally a type and/or severity (e.g. size, severity classification, etc.), of the predicted part defects relative to the one or more parts.

It should be understood that the various types of models described herein may either be used separately from one another and/or in combination with one another as the disclosure is not so limited. Additionally, appropriate amounts and types of training data as well as types of model for the different methods are described further below.

In the various embodiments described herein, one or more photosensitive detectors may be used to capture one or more images of a build surface. Depending on the specific embodiment, the one or more photosensitive detectors may either image the entire build surface simultaneously and/or one or more photosensitive detectors may be scanned across the build surface to capture a composite image of the build surface. For example, one or more photosensitive detectors may be moved in sync with an optical assembly of an additive manufacturing system as the welds are formed on a build surface to capture the composite image. In either case, it should be understood that the current disclosure is not limited to any specific type, number, arrangement, and/or use of the one or more photosensitive detectors. Additionally, appropriate types of photosensitive detectors may include, but are not limited to, area cameras, line scan cameras, contact sensors and/or any other appropriate type of photosensitive detector as the disclosure is not so limited.

In some embodiments, the analysis and imaging techniques disclosed herein may permit the use of lower resolution images than are typically used for weld and/or part defect detection. This may offer benefits including reduced economic and processing costs associated with the photosensitive detectors and methods disclosed herein. In some such embodiments, a photosensitive detector may include pixels with per-pixel fields of view of the build surface with widths that are on the order of 0.01 to 0.5 times a width of a weld size formed on a build surface. In some such embodiments, the pixels may have fields of view with areas of the build surface that are greater than or equal to 1 um×1 um per-pixel, and/or any other appropriate range. The pixels may also have fields of view of the build surface with areas that are less than or equal to 250 um×250 um per-pixel, and/or any other appropriate range. Combinations of the foregoing are contemplated including, for example pixels of the photosensitive detector may have fields of view of the build surface with areas that are between or equal to 1 um×1 um per-pixel and 250 um×250 um per-pixel. Of course, ranges of areas both greater than and less than those noted above are also contemplated as the disclosure is not so limited. Such a system could be serialized to account for areas exceeding such a range listed above, through duplication of the photosensitive detection system.

Either due to the overall size of a field of view of the one or more photosensitive detectors used in an additive manufacturing system and/or scanning of the one or more photosensitive detectors across a build surface, the one or more photosensitive detectors may be configured to image a build surface with any appropriate size. This may include build surfaces with areas that are greater than or equal to 0.5 m², 1 m², 5 m², 10 m², 15 m², and/or any other appropriate area. The build surfaces may also have areas that are less than or equal to 25 m², 20 m², 15 m², 10 m², 5 m², 1 m², and/or any other appropriate area. Combinations of the foregoing are contemplated including, for example, build surfaces with areas that are between or equal to 0.5 m² and 25 m², 1 m² and 25 m², 10 m² and 25 m², and/or any other appropriate combination. Of course build surfaces with areas both greater than and less than those noted above are also contemplated as the disclosure is not so limited.

The currently disclosed methods and systems may offer a number of benefits. For example, determining the presence of defects during a build process may allow for cancellation of the build process for one or more parts and/or adjustment of one or more process parameters in an attempt to mitigate the identified and/or predicted defects. For example, adjusting the parameters of the build process may help to prevent the part from becoming defective, and cancelling the build process may help to conserve resources. For example, identifying weld and/or part defects earlier during a build process may enable either correction and/or cancelling of the part earlier during a build process which may help to minimize wasted material, time, and/or other costs associated with finishing a build of a defective part. This may also permit the canceling of the build process for one or more defective parts while continuing the build process for the remaining non-defective parts on the build surface which may also allow non-defective parts to be completed sooner. By stopping production of defective parts and continuing production of non-defective parts, the efficiency of quality inspection may also increase by foregoing inspection of parts already known to be defective. In addition, identified and/or predicted defects may be used during quality inspection to help aid in inspecting potentially defective parts more quickly. For example, a location of an identified and/or predicted defect, such as weld or part defect, may be directly inspected rather than a more general inspection of a part.

As used herein, the terms weld, weld line, and other similar terms may be used interchangeably. Specifically, in some embodiments, a weld or weld line may refer to a continuous portion of a build surface including a precursor material that has been fused together to form a solid portion of the precursor material layer. Multiple welds and/or multiple portions of a single weld may be disposed adjacent to one another such that when combined the fused together portions of the build surface may form any desired shape. In some embodiments, the precursor material may be a powder (e.g. a ceramic, metal, polymer, composite, or other appropriate type of fusible powder). The precursor material may be fused in any appropriate manner. For example, in some embodiments, an additive manufacturing system implementing the methods disclosed herein may be a powder bed fusion additive manufacturing system in which case lasers, or other appropriate energy sources, may be scanned across the build surface to melt, sinter, react, or otherwise fuse the precursor material to form the desired welds on the build surface. This direction of travel of the lasers across the build surface may cause the welds to propagate across the build surface in the same direction during weld formation. This direction of travel of the lasers and welds may be referred to herein as a fusion direction.

As noted above, one or more portions of a build surface including a precursor material may be fused together to form individual layers of one or more parts being formed by an additive manufacturing system. Thus, sequential layers of precursor material may be deposited on the build surface and selectively fused in the desired areas to iteratively form different layers of the one or more parts. These separate layers of the one or more parts may be referred to as build layers.

While powder bed fusion additive manufacturing systems are noted above, it should be understood that the various methods and systems disclosed herein may be used with any appropriate type of additive manufacturing method in which a fusible precursor material is somehow fused to provide a solid weld within a build layer as the disclosure is not limited in this fashion.

In some embodiments, incident laser spots on a build surface may be arranged in a line with a long dimension and a short dimension, or in an array. In either case, according to some aspects, a line, or array, of incident laser energy consists of multiple individual laser energy pixels arranged adjacent to each other that can have their respective power levels individually controlled. Each laser energy pixel may be turned on or turned off independently and the power of each pixel can be independently controlled. The resulting pixel-based line or array may then be scanned across a build surface to form a desired pattern thereon by controlling the individual pixels during translation of the optics assembly.

Depending on the particular embodiment, an additive manufacturing system according to the current disclosure may include any suitable number of laser energy sources. For example, in some embodiments, the number of laser energy sources may be at least 5, at least 10, at least 50, at least 100, at least 500, at least 1,000, at least 1,500, or more. In some embodiments, the number of laser energy sources may be less than 2,000, less than 1,500, less than 1,000, less than 500, less than 100, less than 50, or less than 10. Additionally, combinations of the above-noted ranges may be suitable. Ranges both greater and less than those noted above are also contemplated as the disclosure is not so limited.

Additionally, in some embodiments, a power output of a laser energy source (e.g., a laser energy source of a plurality of laser energy sources) may be between about 50 W and about 2,000 W (2 KW). For example, the power output for each laser energy source may be between about 100 W and about 1.5 kW, and/or between about 500 W and about 1 kW. Moreover, a total power output of the plurality of laser energy sources may be between about 500 W (0.5 KW) and about 4,000 kW. For example, the total power output may be between about 1 kW and about 2,000 kW, and/or between about 100 kW and about 1,000 kW. Ranges both greater and less than those noted above are also contemplated as the disclosure is not so limited.

Depending on the embodiment, an array of laser energy pixels (e.g., a line array or a two dimensional array) may have a uniform power density along one or more axes of the array including, for example, along the length dimension (i.e. the longer dimension) of a line array. In other instances, an array can have a non-uniform power density along either of the axes of the array by setting different power output levels for each pixel's associated laser energy source. Moreover, individual pixels on the exterior portions of the array can be selectively turned off or on to produce an array with a shorter length and/or width. In some embodiments, the power levels of the various pixels in an array of laser energy may be independently controlled throughout an additive manufacturing process. For example, the various pixels may be selectively turned off, on, or operated at an intermediate power level to provide a desired power density within different portions of the array.

Generally, laser energy produced by a laser energy source has a power area density. In some embodiments, the power area density of the laser energy transmitted through an optical fiber is greater than or equal to 0.1 W/μm², greater than or equal to 0.2 W/μm², greater than or equal to 0.5 W/μm², greater than or equal to 1 W/μm², greater than or equal to 1.5 W/μm², greater than or equal to 2 W/μm², or greater. In some embodiments, the power area density of the laser energy transmitted through the optical fiber is less than or equal to 3 W/μm², less than or equal to 2 W/μm², less than or equal to 1.5 W/μm², less than or equal to 1 W/μm², less than or equal to 0.5 W/μm², less than or equal to 0.2 W/μm², or less. Combinations of these ranges are possible. For example, in some embodiments, the power area density of the laser energy transmitted through the optical fiber is greater than or equal to 0.1 W/μm² and less than or equal to 3 W/μm².

Depending on the application, output of the optics assembly may be scanned across a build surface of an additive manufacturing system in any appropriate fashion. For example, in one embodiment, one or more galvo scanners may be associated with one or more laser energy sources to scan the resulting one or more laser pixels across the build surface. Alternatively, in other embodiments, an optics assembly may include an optics head that is associated with one or more appropriate actuators configured to translate the optics head in a direction parallel to a plane of the build surface to scan the one or more laser pixels across the build surface. In either case, it should be understood that the disclosed systems and methods are not limited to any particular construction for scanning the laser energy across a build surface of the additive manufacturing system.

For the sake of clarity, transmission of laser energy through an optical fiber is described generically throughout. However, with respect to various parameters such as transverse cross-sectional area, transverse dimension, transmission area, power area density, and/or any other appropriate parameters related to a portion of an optical fiber that the laser energy is transmitted through, it should be understood that these parameters refer to either a parameter related to a bare optical fiber and/or a portion of an optical fiber that the laser energy is actively transmitted through such as an optical fiber core, or a secondary optical laser energy transmitting cladding surrounding the core. In contrast, any surrounding cladding, coatings, or other materials that do not actively transmit the laser energy may not be included in the disclosed ranges.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

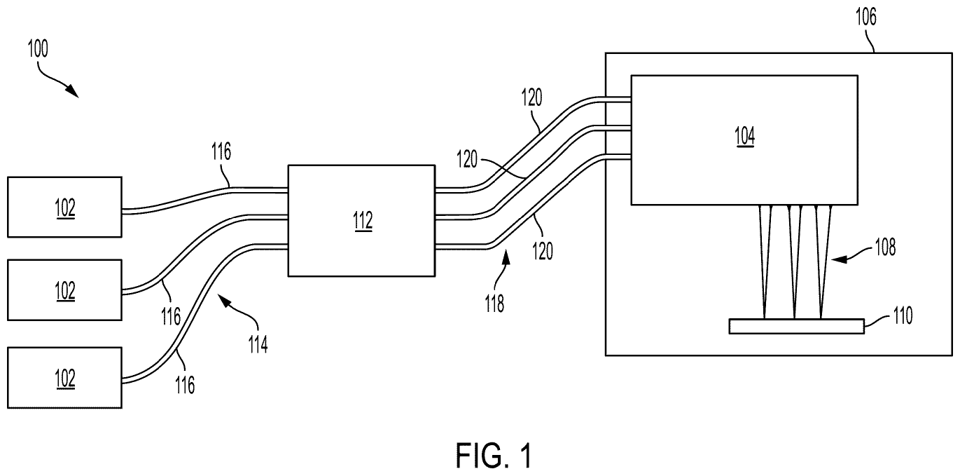

FIG. 1 shows, according to some embodiments, a schematic representation of an additive manufacturing system 100, including a plurality of laser energy sources 102 that deliver laser energy to an optics assembly 104 positioned within a machine enclosure 106. For example, the machine enclosure may define a build volume in which an additive manufacturing process may be carried out. In particular, the optics assembly may direct laser energy 108 towards a build surface 110 positioned within the machine enclosure to selectively fuse powdered material on the build surface. As described in more detail below, the optics assembly 104 may include a plurality of optics defining an optical path within the optics assembly that may transform, shape, and/or direct laser energy within the optics assembly such that the laser energy is directed onto the build surface as an array of laser energy pixels. In some embodiments, the optics assembly may be movable within machine enclosure 106 to scan laser energy 108 across build surface 110 during a manufacturing process. For example, the optics assembly may be associated with appropriate actuators, rails, motors, and/or any other appropriate structure capable of optics assembly relative to the surface. Alternatively, embodiments in which the optics assembly includes galvomirrors or other appropriate components that are configured to scan the laser energy 108 across the build surface while the optics assembly is held stationary relative to the build surface are also contemplated.

In some embodiments, the additive manufacturing system 100 further includes one or more optical fiber connectors 112 positioned between the laser energy sources 102 and the optics assembly 104. As illustrated, a first plurality of optical fibers 114 may extend between the plurality of laser energy sources 102 and the optical fiber connector 112. In particular, each laser energy source 102 may be coupled to the optical fiber connector 112 via a respective optical fiber 116 of the first plurality of optical fibers 114. Similarly, a second plurality of optical fibers 118 extends between the optical fiber connector 112 and the optics assembly 104. Each optical fiber 116 of the first plurality of optical fibers 114 is coupled to a corresponding optical fiber 120 of the second plurality of optical fibers 118 within the optical fiber connector. In this manner, laser energy from each of the laser energy sources 102 is delivered to the optics assembly 104 such that laser energy 108 can be directed onto the build surface 110 during an additive manufacturing process (i.e., a build process). Of course other methods of connecting the laser energy sources 100 due to the optics assembly 104 are also contemplated.

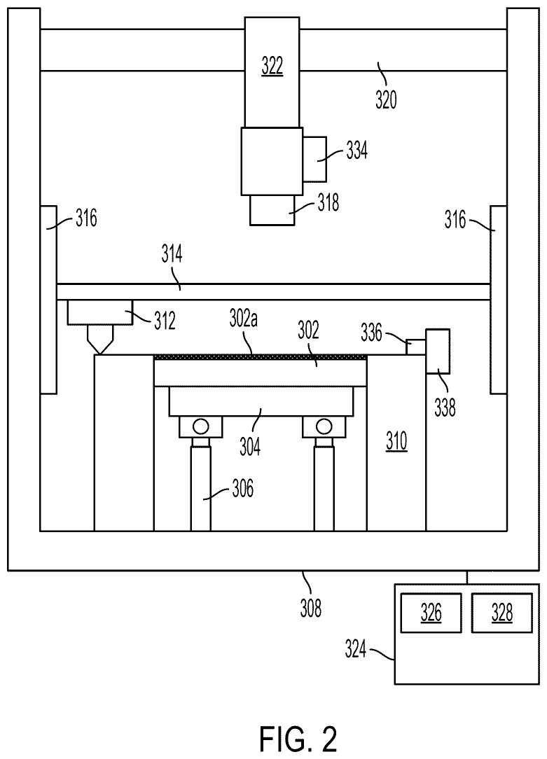

FIG. 2 depicts one embodiment of an additive manufacturing system at the beginning of a build process. The additive manufacturing system includes a build plate 302 mounted on a fixed plate 304, which is in turn mounted on one or more vertical supports 306 that attach to a base 308 of the additive manufacturing system. In the depicted embodiment, the one or more vertical supports may correspond to one, two, and/or any other appropriate number of supports configured to support the build plate, and the corresponding build surface, at a desired position and orientation. For example, the supports depicted in the figure may correspond to one or more vertical motion stages configured to control a vertical position and orientation of the build plate. A powder containment shroud 310 may at least partially, and in some embodiments completely, surround a perimeter of the build plate 302 to support a volume of precursor material 302a, such as a volume of powder, disposed on the build plate and contained within the shroud. The shroud may be supported on the base 308 or by any other appropriate portion of the system.

The additive manufacturing system may include a powder deposition system in the form of a recoater 312 that is mounted on a horizontal motion stage 314 that allows the recoater to be moved back and forth across either a portion, or entire, surface of the build plate 302. As the recoater traversers the build surface of the build plate, it deposits a precursor material 302a, such as a powder, onto the build plate and smooths the surface to provide a layer of precursor material with a predetermined thickness on top of the underlying volume of fused and/or unfused precursor material deposited during prior formation steps.

In some embodiments, the supports 306 of the build plate 302 may be used to index the build surface of the build plate 302 in a vertical downwards direction relative to a local direction of gravity. In such an embodiment, the recoater 312 may be held vertically stationary for dispensing precursor material 302a, such as a precursor powder, onto the exposed build surface of the build plate as the recoater is moved across the build plate each time the build plate is indexed downwards.

In some embodiments, the additive manufacturing system may also include an optics assembly 318 that is supported vertically above and oriented towards the build plate 302. As detailed above, the optics assembly may be optically coupled to one or more laser energy sources, not depicted, to direct laser energy in the form or one or more laser energy pixels onto the build surface of the build plate 302. To facilitate movement of the laser energy pixels across the build surface, the optics assembly may be configured to move in one, two, or any number of directions in a plane parallel to the build surface of the build plate. To provide this functionality, the optics assembly may be mounted on a gantry 320, or other actuated structure, that allows the optics unit to be scanned in plane parallel to the build surface of the build plate.

In the above embodiment, the build plate is indexed vertically while the remaining active portions of the system are held vertically stationary. However, embodiments, in which the build plate is held vertically stationary and the shroud 310, recoater 312, and optics assembly 318 are indexed vertically upwards relative to a local direction of gravity during formation of successive layers are also contemplated. In such an embodiment, the recoater horizontal motion stage 314 may be supported by vertical motion stages 316 that are configured to provide vertical movement of the recoater relative to the build plate. Corresponding vertical motion stages may also be provided for the shroud 310, not depicted, to index the shroud vertically upward relative to the build plate in such an embodiment. In some embodiments, the additive manufacturing system may also include an optics assembly 318 that is supported on a vertical motion stage 322 that is in turn mounted on the gantry 320 that allows the optics unit to be scanned in the plane of the build plate 302.

In the above embodiment, the vertical motion stages, horizontal motion stages, and gantry may correspond to any appropriate type of system that is configured to provide the desired vertical and/or horizontal motion. This may include supporting structures such as: rails; linear bearings, wheels, threaded shafts, and/or any other appropriate structure capable of supporting the various components during the desired movement. Movement of the components may also be provided using any appropriate type of actuator including, but not limited to, electric motors, stepper motors, hydraulic actuators, pneumatic actuators, electric actuators, and/or any other appropriate type of actuator as the disclosure is not so limited.

In addition to the above, in some embodiments, the depicted additive manufacturing system may include one or more controllers 324 that is operatively coupled to the various actively controlled components of the additive manufacturing system. For example, the one or more controllers may be operatively coupled to the one or more supports 306, recoater 312, optics assembly 318, the various motion stages, and/or any other appropriate component of the system. In some embodiments, the controller may include one or more processors and associated non-transitory computer readable memory. The non-transitory computer readable memory may include processor executable instructions that when executed by the one or more processors cause the additive manufacturing system to perform any of the methods disclosed herein.

The one or more controllers 324 may include one or more software modules. In some embodiments, the controller 324 may include a weld quality module 326 and/or a part defect prediction module 328. Appropriate algorithms for implementing these modules are detailed further below.

In some embodiments, one or more photosensitive detectors 334 may be configured to image at least a portion of the build surface and/or surface of the build plate 302. For example, the one or more photosensitive detectors 334 may be configured to move in sync with the optics assembly 318 such that the one or more photosensitive detectors may image the build surface as the optics assembly scans the corresponding laser energy pixels across the build surface to selectively form welds thereon. Thus, the one or more photosensitive detectors may still image a relevant portion, and in some instances the entire build surface, during formation of each layer. This scan based imaging of the build surface may permit detectors with smaller fields of view and lower resolutions to be used, though it should be understood that photosensitive detectors with any appropriate field of view and resolution may be used depending on the application.

As noted above, the one or more photosensitive detectors 334 may be movable with respect to the surface of the build plate 302. Optionally, the photosensitive detectors 334 may be coupled to the optics assembly 318 and may move together with the optics head assembly. In other embodiments, the photosensitive detectors 334 may be coupled to the gantry 320 and/or the vertical motion stage 322. In further embodiments, the photosensitive detectors 334 may move independently of the movement of the optics head assembly 318 and vertical motion stage 322. For example, the photosensitive detectors 334 may be coupled to a separate movable y-bridge or other appropriate motion stage. In either case, the one or more photosensitive detectors 334 may be configured to obtain images from an orientation that is substantially perpendicular to the surface of the build plate to obtain top-down images of the powder bed and welded surfaces in the various embodiments described herein.

In some embodiments, one or more sensors 336 may be included in the additive manufacturing system. The sensors may be configured to sense any appropriate process parameter associated with a build process and may be coupled to any appropriate portion of the additive manufacturing system. The one or more sensors 336 may collect information related to one or more of the following process parameters: temperature, scanning speed of the laser pixels relative to the build surface, orientation of the build surface, laser power, total energy per unit area, laser pixel size, air flow, air flow speed, weld spacing, combinations of the foregoing and/or any other appropriate parameter, precursor material state, precursor material coverage, and/or any other appropriate operating parameter. In some embodiments, the one or more sensors 336 may include one or more of the following: a thermocouple, photosensitive detector, accelerometer, gyroscope, force sensor, torque sensor, encoder, distance sensor, pressure sensor, air flow sensor, light sensors, pyrometers, optical coherence tomography, laser displacements sensor, laser line height mapping tool, and/or any other appropriate type of sensor configured to sense the desired operating parameter. The one or more sensors 336 may output signals including information related to the process parameters to the one or more controllers 324. For example, a sensor 336 may be a thermocouple configured to obtain information related to temperature during the build process and provide the information to the controller for subsequent use. Of course, while specific types of process parameters and sensors are noted above, any appropriate sensor capable of sensing any desired process parameter related to weld defects and/or part defects may be used as the disclosure is not so limited.

To help with imaging, an additive manufacturing system may also include one or more light sources 338 configured to illuminate the build surface of the build plate 302. In some embodiments, the one or more light sources 338 may be configured to provide light that has a direction of primary propagation that is approximately parallel to the top surface of the build plate (i.e., the light sources may be oriented parallel to the build surface). As discussed further below, multiple light sources 338 may be arranged around the build surface such that they provide light in directions that are approximately perpendicular to potential welding directions of the additive manufacturing system to provide appropriate lighting in these different directions.

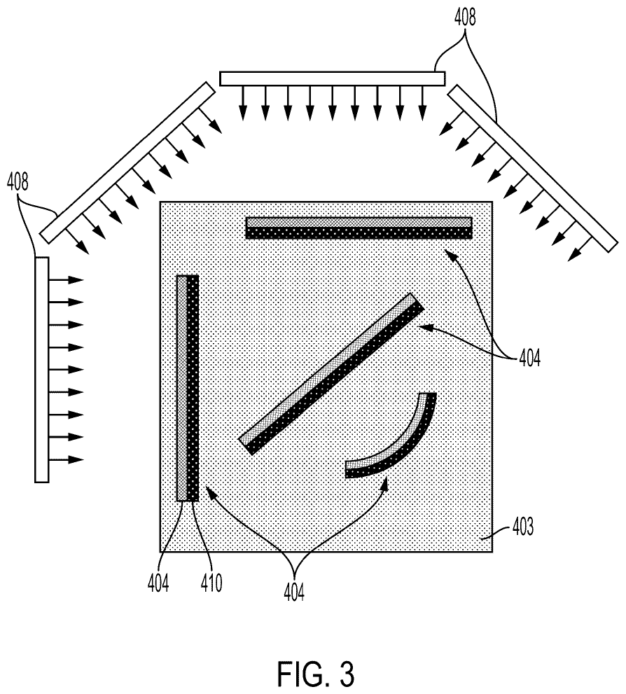

FIG. 3 shows an arrangement of one or more light sources 408 and a build surface 403 according to some embodiments. One or more welds 404 may be formed on the build surface 403 during a build process of one or more parts. The welds 404 may be formed in any geometry or direction, with some example geometries and directions illustrated in the figure. One or more light sources 408 may be configured to direct light onto at least a portion of the build surface 403. In some embodiments, the light sources 408 may be configured to emit light in a direction that is substantially parallel to the build surface 403 (e.g., a direction of primary light propagation may be substantially parallel to the build surface). The light sources 408 may be located at any location and orientation around a perimeter of the build surface 403 to provide light to the build surface. Optionally, a plurality of light sources 408 may partially or completely surround the build surface to illuminate the build surface from multiple different directions. As shown in the figure, the welds 404 formed on the build surface 403 may be illuminated by the light sources 408.

Depending on an orientation of a light source relative to a weld 404 and a height of the weld 404 relative to the build surface 403, a shadow 410 may be projected onto the build surface 403 on a side of the weld opposite a light source forming the shadow. Directing light in directions approximately perpendicular to a direction of fusion may form more pronounced and identifiable shadows. In many embodiments, any number of directions of fusion may be possible. Thus, a plurality of light sources 408 may be arranged at different locations and orientations around a perimeter of a build surface to permit illumination of these welds from different orientations. Further, in some embodiments, the one or more light sources that are operated to emit light to aid in imaging of a weld being formed may be the light source(s) that emit light that is oriented closest to perpendicular to the current direction of fusion of the additive manufacturing system. Thus, by selectively activating the light sources, the direction of light illumination on the build surface 403 may be controlled which may control the expected direction, size, and shape of the shadows 410 formed on the build surface 403 associated with the welds 404. Appropriate types of light sources may include, but are not limited to spot lights, bar lights, LED strip lights, and focused beam lights.

As noted above, in some embodiments, one or more photosensitive detectors may be configured to obtain one or more images of at least a portion of the build surface 403 containing the welds 404 and the shadows 410. Thus, forming pronounced shadows may help to enable the use of lower resolution photosensitive detectors, by exaggerating the topography of the weld on the build surface 403, though again any appropriate photosensitive detector with any appropriate resolution may be used. In some embodiments, the photosensitive detectors may be configured to obtain grayscale images of the build surface 403. In other embodiments, colored images may be obtained using the photosensitive detectors. The welds 404 formed on the build surface 403 in FIG. 3 of various directions may be high-quality weld lines where the welds are continuous and aligned with their respective intended directions of fusion. For example, the curved weld on the build surface 403 is continuous such that an image of both the curved weld, and the corresponding shadow 410, may be continuous and located in an expected location on the build surface.

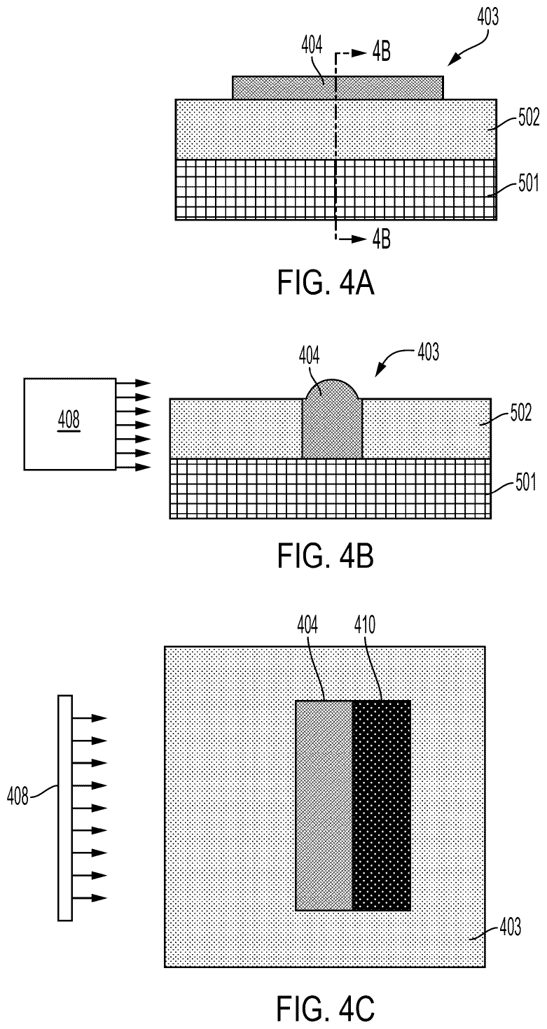

FIG. 4A shows a side view of a build surface 403 containing a continuous high quality weld 404. FIG. 4B shows a light source 408 and a cross-section view of the build surface and the weld of FIG. 4A from a perpendicular side cross sectional view taken along line 4B-4B. FIG. 4C shows the light source 408, build surface 403, and weld 404 of FIG. 4A from a top view of the build surface. As is depicted in the figure, a build plate 501 may support a volume of powder 502. The powder 502, or other appropriate precursor material, may have a build surface 403 on which the one or more welds 404 may be formed by fusing the powder to form the welds as described previously. One or more light sources 408 may illuminate the build surface 403 and the one or more welds 404 in a direction that is at least partially perpendicular to a fusion direction of the one or more welds. This may cause one or more shadows 410 to be projected onto the build surface 403 on a side of the welds opposite from the one or more light sources emitting the light. In the embodiment depicted in FIGS. 4A-4C, the weld 404 is continuous and does not contain any weld defects. Thus, the continuous weld may result in a continuous shadow being projected onto the build surface 403 as shown in FIG. 4C. Again, this continuous shadow may be imaged by a corresponding photosensitive detector and subsequently used to determine that no weld defects are present as elaborated on further below.

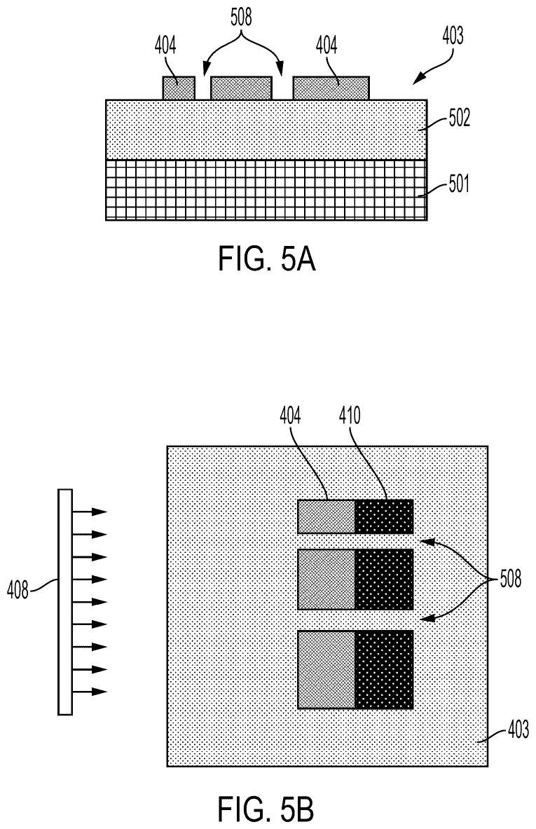

FIG. 5A shows a side view of an embodiment of a build surface 403 similar to that described above with regards to FIGS. 4A-4C. However, in this embodiment, the build surface includes a weld 404 including one or more weld defects 508 formed along a length of the weld. FIG. 5B again shows a light source and a top view of the build surface of FIG. 5A including the weld 404 with one or more weld defects 508. In the depicted embodiment, the weld line includes two gaps between the non-defective portions of the weld. This results in two discontinuities along the length of the weld corresponding to the noted weld defects 508. These discontinuities in the weld line also result in discontinuities in the shadows 510 projected from the weld line. Thus, an image of the build surface from the top orientation shown in FIG. 5B may include reflected light from the weld line 404, the projected shadows 410 extending away from the continuous portions of the weld, as well as the gaps (i.e., defects) disposed between the continuous portions of the weld and shadows. As elaborated on further below, an image of a build surface including discontinuous welds and/or shadows on a portion of a build surface where a continuous weld and/or shadow is expected may be used to identify the presence of weld defects on the build surface as elaborated on further below.

In addition to the above, balling defects may also produce a distinctive combination of reflections and shadows when the build surface is imaged. The reflections and shadows formed on the build surface and/or part area may indicate balling defects or any other defects, including welds with inappropriate surface textures. Examples of inappropriate surface textures include bumps, crevices, or other roughness. These surface textures may also result in discontinuities as well as welds being formed in directions that are not aligned with a commanded direction of fusion.

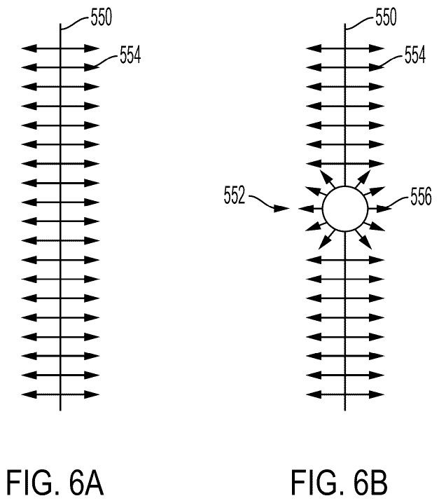

FIG. 6A shows an image of a continuous high quality weld 550 extending along a linear path, though paths of a weld line that are non-linear such that the weld line includes curves, turns, or other non-linear features are also contemplated. In either case, the weld may be illuminated from an appropriate light source as previously described. This light may interact with the weld such that at least a portion of the light is reflected or otherwise scattered from a surface of the weld. When imaged, a gradient of the light intensity, see arrows 554, associated with the weld may be determined. For example, a direction, or directions, of the greatest rate of change of the light intensity in the image along a length of the weld may be determined by determining a local derivative of the light intensity for each pixel and/or using any standard imaging analysis software for determining light gradients within an image. In instances in which a continuous high quality weld is imaged, as shown in FIG. 6A, the determined gradient directions may be substantially perpendicular to the direction of fusion of the weld 550 along a length of the weld.

In contrast to the above, FIG. 6B shows a schematic image of a weld line containing a defect 552 located along a length of the weld. In this case, the determined light gradients on either side of the weld change along a length of the weld. Specifically, continuous portions of the weld that are without defects may exhibit light gradients that may still extend in directions that are substantially perpendicular to a fusion direction of the weld, see the arrows 554 corresponding to the light gradients associated with the continuous portions of the weld. However, in instances in which a weld defect is observed the relationship between the fusion direction and the direction of the light gradient may change. For example, in the depicted embodiment, a balling defect, represented by the weld defect 552, is formed along a length of the weld 550. In the one or more portions of the weld 550 including the one or more defects 554, one or more of the determined light gradients, see arrows 556, may be oriented in a direction that is at least partially not perpendicular to a fusion direction of the weld line 550. Additionally, as shown by the indicated gradient directions around the balling defect 554, the gradients may point away from the weld defect in a plurality of different directions around a perimeter of the weld defect. Accordingly, in some embodiments, the detection of light gradients in directions that are not substantially perpendicular to a fusion direction and/or otherwise are oriented in directions different than those expected along a weld line may be indicative of the presence of a weld defect. The identification of light gradients that extend in multiple different directions around a particular portion of a weld may also be used to indicate the presence of a weld defect. Of course, other effects on light scattering during imaging of different weld defects may occur given the somewhat random nature associated with the formation and solidification of welds during a build process.

Given the statistical nature of weld formation, it may be difficult to determine absolute rules to accurately identify light gradients associated with a weld defect. Instead, the Inventors have recognized the benefits associated with using a proportion of gradients orthogonal to the direction of fusion of a portion of a weld to determine a quality of the weld and/or identify likely weld defects located along a length of the weld as discussed further below.

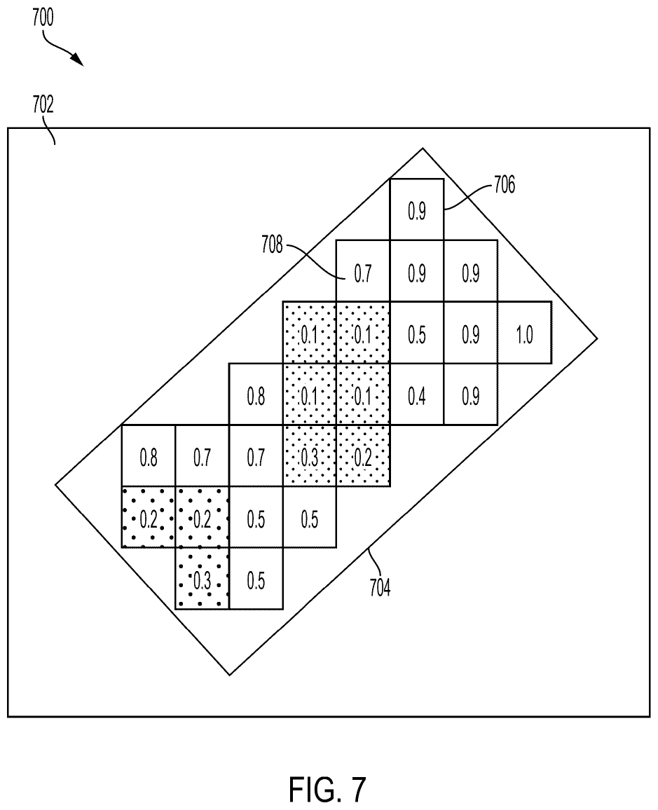

FIG. 7 shows one embodiment of a method that may be used for evaluating the welds formed on one or more portions of a build surface. In the depicted embodiment, a score map 700 may be determined for a layer of one or more parts, see part area 704, being formed on a build surface 702 during a build process. It should be understood that a separate score map may be generated for each layer of the plurality of layers formed during a build process of the one or more parts. The score map 700 may contain one or more part areas 704 where a plurality of welds have been formed to fuse the precursor material contained on the build surface to form a single layer of the one or more parts. The part area may be subdivided into regions 706 where each region may include a plurality of pixels. Depending on the relative size of the welds and defined regions, the regions may either include a portion of a weld, a single weld, or multiple welds. In some instances, a size of a weld may be substantially matched to the expected size of a weld formed on the build surface.

As shown in the figure, the score map 700 may include a region score 708 that is determined for and associated with each region 706. The score may be indicative of the weld quality of the region. For instance, scores above a threshold score or other metric may be indicative of high quality welds and scores less than a threshold may be used to identify that a weld defect is likely included in the associated region of the build surface. This is indicated by the shaded regions in the figure with scores less than a threshold score which may be identified as being weld defects. The score associated with each region may be determined based on a number of different factors depending on the specific embodiment. For example, weld defects in a region may be identified, and/or a score may be determined for a region, based, on one or more of the following: a proportion of light intensity gradients perpendicular to an associated fusion direction of a weld; the presence of weld defects in corresponding portions of adjacent build layers (e.g., low weld scores in the same regions in score maps associated with sequentially formed build layers); and/or any other appropriate parameter. Specific methods for identifying weld defects and/or determining a score based on the forgoing is described in further detail below.

In some embodiments, the scores 708 of a layer may be normalized to compare scores more easily. The resulting normalized scores may form a range in which all scores of the layer may be within. For example, in some embodiments, the normalized scores for a layer may range from 0 to 1, be output as a percentage, or presented along any other appropriate scale. The formation of the score map 700 and the calculation of the scores 708 are discussed further below.

Depending on the specific additive manufacturing system being used and the anticipated operating parameters (e.g., expected weld size), the subdivided regions of a build surface that may be included in a map may have any appropriate area. For example, in some embodiments, the area for each region may be greater than or equal to about 0.04 mm², 0.1 mm², 0.2 mm², 0.3 mm², 0.5 mm², 1 mm², 2 mm², 3 mm², and/or any other appropriate area. The area for each region may also be less than or equal to 25 mm², 20 mm², 15 mm², 10 mm², 5 mm², 4 mm², 3 mm², 2 mm², 1 mm² and/or any other appropriate area. Combinations of the foregoing are contemplated including, for example, an area of the regions of a map that is between or equal to 0.04 mm² and 25 mm², 0.1 mm² and 5 mm², and/or any other appropriate combination. It should be understood that ranges both greater than and less than those noted above are also contemplated as the disclosure is not so limited.

In view of the above, each region 706 of the subdivided image of the build surface 702 may contain a certain number of pixels. In some embodiments, each region may include greater than or equal to 1 pixel, 4 pixels, 9 pixels, 16 pixels, 25 pixels, 36 pixels, 100 pixels, 256 pixels, 400 pixels, and/or any other appropriate number of pixels. Correspondingly, the region may include less than or equal to 1000 pixels, 400 pixels, 256 pixels, 100 pixels, and/or any other appropriate number of pixels. Combinations of foregoing are contemplated including, for example, between or equal to 1 pixel and 1000 pixels, 25 pixels and 256 pixels, and/or any other appropriate combination. Of course, ranges both greater than and less than those noted above are also contemplated as the disclosure is not so limited.

In the depicted embodiment, the subdivided regions 706 of the part area 704 are depicted as being square shaped. However, it should be understood that the regions may be formed using any appropriate shape. For example, in some embodiments, the subdivided regions may include shapes such as rectangles, hexagons, and/or any other appropriate shape as the disclosure is not so limited.

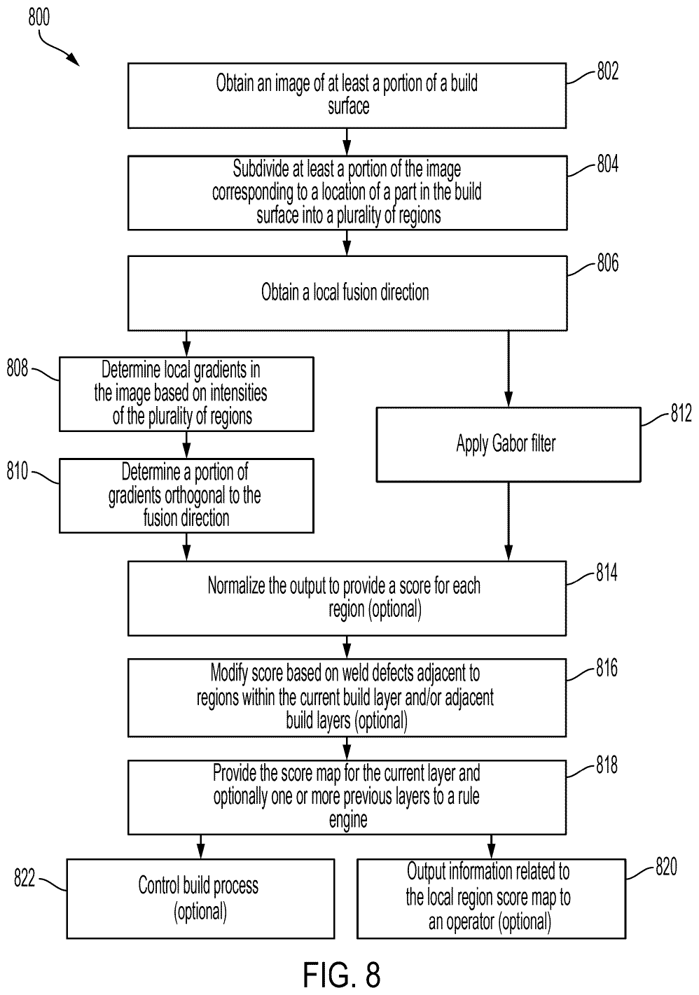

FIG. 8 is a flow diagram of one embodiment of a method 800 for identifying the presence of weld defects in a build layer based on a portion of light intensity gradients that are perpendicular to an associated fusion direction of the welds. Specifically, the depicted method illustrates one embodiment of generating a score map and controlling one or more aspects of a build process. The first step of the method 800 may be obtaining one or more images of at least a portion of a build surface after formation of one or more welds thereon, see 802. The images may be obtained in any appropriate manner including, but not limited to, receiving the image from one or more photosensitive detectors, recalling the image from memory, downloading the image from a remotely located database, and/or any other appropriate method. In some embodiments, the images may be grayscale. As noted above, the imaged build surface may include one or more parts having a fused layer visible in the image corresponding to the presence of the plurality of welds.

At least a portion of the images corresponding to a location of a part in the build surface may then be subdivided into a plurality of regions at 804. In some embodiments, the areas containing parts for a current layer may be known and may be provided as an input to determine a portion of the build surface to be subdivided into the plurality of regions. For example, a build plan that may optionally be obtained may include areas to be fused to form the one or more parts. Using this information, the part areas may optionally be provided in the form of a part mask (e.g., a binary mask) indicating the areas of a build surface containing the one or more parts being formed therein. For example, the binary mask may indicate a region as having a value of 0 if there is no part area contained in the region and may indicate a region as having a value of 1 if there is a part are contained in the region. However, other methods for identifying the locations of parts on the build surface may also be used including, for example, using a threshold light intensity to identify regions of the build surface including welds (e.g., light intensities greater than a threshold intensity). Regardless, once one or more portions of the build surface have been identified as part areas including the plurality of welds, the one or more part areas may be subdivided into a plurality of regions. As noted above, the plurality of regions may be non-overlapping and may be substantially equal in area.

A local fusion direction may be obtained for each region at 806. For example, a build plan may include a fusion direction for a particular weld associated with a map being generated. Thus, a fusion direction for a corresponding portion of a build plan associated with each region may be identified to determine a local fusion direction for each region. The fusion direction can also be estimated using local dominating weld line directions as described further below. Of course, other ways of providing the local direction of fusion for the regions in a current layer may also be used.

In some embodiments, information related to the gradients of the light intensity in the image may be determined for the plurality of regions. Two potential algorithms for evaluating the light intensity gradient associated with the one or more welds in each region are provided below.

In one embodiment, a magnitude and intensity of a gradient of the light intensity between pixels may be determined for the different regions at 808. The proportions of the determined gradients perpendicular to and not perpendicular to a fusion direction may then be determined for a given region at 810. For example, the different gradients for a region may be grouped based on gradient direction to determine a number of gradients oriented in a plurality of different directions. For instance, the different gradients may be binned into different direction bins. In some embodiments, a weighted histogram of gradient direction may then be determined using the binned gradients. A proportion (e.g., a ratio, percentage, or other measure) of the gradients perpendicular to the fusion direction may then be determined. For example, the number of pixels in a region with light intensity gradients that are substantially perpendicular to the fusion direction may be compared to the overall number of pixels in that region. The bins may include any appropriate range of orientations in each bin to provide a desired accuracy in determining whether or not a weld defect is present.

As an alternative to the above, in some embodiments, a Gabor filter, or a 2D filter bank, or one or multiple convolutional layers associated with the fusion direction and weld line spacing may be applied to each region. For example, a Gabor filter associated with the fusion direction of a specific region may be applied to the portion of the image corresponding to that region to determine a floating number or other output from the Gabor filter at 812. This may be continued until an output is obtained from each region to be analyzed. Without wishing to be bound by theory, greater outputs from the Gabor filter in this case may be associated larger intensity changes in directions perpendicular to the fusion direction, which as noted above may correspond to higher-quality welds.

It should be understood that while two potential methods for evaluating whether or not light intensity gradients are perpendicular to a corresponding fusion direction within a given region are described above, any appropriate method capable of performing similar types of comparisons may be used as the disclosure is not limited to only using these specific methods.

In the above embodiments, if a local fusion direction is not provided, the above calculations may be performed across all possible fusion directions and the fusion direction with the maximum resulting output may be assumed to be the fusion direction of that region. The fusion direction with the maximum resulting output may be considered a local dominating weld line direction. For example, in one embodiment, the proportion of gradients orthogonal to each possible fusion direction for a region may be calculated. The fusion direction with the highest proportion of orthogonal gradients may then be used as the fusion direction for the region for use in the above described method. This may be done for each region to be analyzed. In another embodiment, a fusion direction exhibiting a maximum output from a Gabor filter for the different potential fusion directions may be used as the fusion direction for that region. Again, this may be done for each region to be analyzed. The output from this optional step may also be used for determining the score and other subsequent usages as detailed herein.

Given differences in patterns to be formed, lighting, and any number of other possible variations, the intensities and outputs from the above steps analyzing the light intensity, different magnitude outputs may be obtained for different images. Therefore, to simplify analysis and comparison, it may be desirable to normalize the outputs related to the light intensity analysis to a desired scale to provide a score at 814. For example, an output from the light intensity analysis may be normalized using a maximum output (e.g., a maximum percentage, output from a Gabor filter, or other output) associated with the different regions. The resulting normalized scores may be associated with the different regions to generate a two-dimensional score map for the one or more parts contained on the build surface in the image. Of course, instances in which the scores included in the score map are not normalized are also contemplated.

Weld defects can vary in severity, with some defects being more likely to make a part defective than others. In some cases, a weld defect present in a single layer can be mitigated by a weld on a proceeding layer, reducing or eliminating the impact of the weld defect on the quality of the part. For example, a discontinuity occurring on a first layer may be filled during remelting of the layer during welding of a second layer located sequentially above the first layer. Thus, the severity of a weld defect may be impacted by the presence of other proximate weld defects located adjacent to a weld defect in a current layer. For instance, several discontinuities proximate to one another on sequentially located layers may form one or more larger discontinuities, create stress concentrators, and/or otherwise form defects that increase a likelihood of a part being defective.

In view of the above, in some embodiments, a score of a particular region may be modified based on the identification of other weld defects located in adjacent regions either in the current layer and/or in one or more prior layers as determined using one or more score maps associated with the one or more prior layers, see 816. For example, if a weld defect is identified in the last build layer, a score associated with the corresponding region in the current score map may be decreased by a predetermined value to indicate an increased likelihood of weld defects occurring in this location. Stated in another way, a score map of a first layer may be used at least in part to create a score map of a second, sequentially proceeding score map. For example, a first region on the first layer may contain a weld defect and have a low associated score, and a second region on the second layer may be located proximate to the first region and may receive a lower score in light of the proximity to the region having a lower score (e.g., below a threshold) in an adjacent build layer.

The two-dimensional score map for the current and one or more previous layers may then be provided to a rule engine, see 818. Depending on the embodiment, a rule engine may identify a weld defect in a number of different ways. In some embodiments, the rules engine may determine the presence of a weld defects based on a threshold score or other value. For example, regions with scores greater than the threshold may indicate acceptable welds and regions with scores less than the threshold may be used to identify the presence of weld defects in those regions. In some instances, multiple thresholds may be used to identify weld defects with different severities. For example, a first threshold may be indicative of minor weld defects and a second lower threshold may be indicative of major weld defects. In one such embodiment, a process may continue if weld defects between the first and second thresholds are identified, but a build process may be paused for either corrective actions and/or user input if welds with scores less than the second threshold indicative of major weld defects are identified.

Depending on the embodiment, information related to the score map may optionally be provided to an operator at 820 via any appropriate type of output (e.g., visual, audible, or other observable output). For instance, the location and severity of identified defects and/or the score map may be output to the suer. Alternatively, one or more aspects of the build process may be controlled at 822 based on an output from the rules engine. In some embodiments, the build process may be controlled manually while in other embodiments the build process may be controlled automatically based on the identification of one or more weld defects. One example of controlling the build process is stopping the build process for one or more parts predicted to be defective based on the observed severity and/or number of identified weld defects in one or more build layers. Alternatively, in some embodiments, a corrective action may be taken for the part containing identified weld defects. For example, corrective actions may include, but are not limited to changing one or more process parameters (temperature, scanning speed of the laser pixels relative to the build surface, orientation of the build surface, laser power, total energy per unit area, laser pixel size, air flow, air flow speed, weld spacing, combinations of the foregoing and/or any other appropriate parameter), alerting a user to the occurrence of weld defects of a particular severity needing user intervention, carly termination of parts, and/or any other appropriate corrective action that may be taken to address the observed weld defect.

It should be understood that the above method has been described relative to a single build layer. However, this method may be applied to each build layer during a build process of the one or more parts to generate a score map for each build layer. Thus, this method may be repeated for each build layer in some embodiments.

The above-described weld quality monitoring module may enable the easy identification of parts that are likely to include part defects of various severities as well as the locations of those part defects. Accordingly, the inventors have recognized that it may be possible to easily identify parts as well as locations within those parts for subsequent analysis to create training data for use with a statistical model for help in predicting the formation of part defects during a build process. For example, in some instances parts may either be randomly selected for analysis to identify part defects contained therein and/or parts exhibiting weld defects greater than a predetermined severity may be selected. The parts may then be subjected to various analysis techniques such as computed tomography scans, microscopic examination, visual inspection, cross-sectioning, and/or other appropriate methods capable of identifying a location and severity of part defects in the parts. In either case, a set of training data may be obtained including the location and optionally a characterization of the part defects (e.g., a size, type, and/or severity of the part defect) formed in a part as well as information related to the build process. For example, weld quality data such as the above described weld scores included in a set of score maps associated with the different build layers of a part may be used.

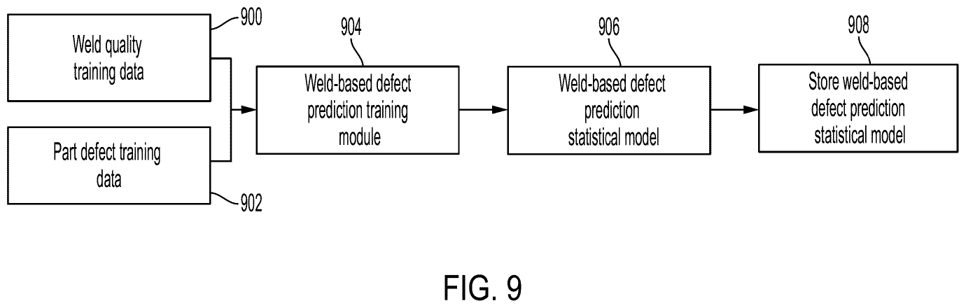

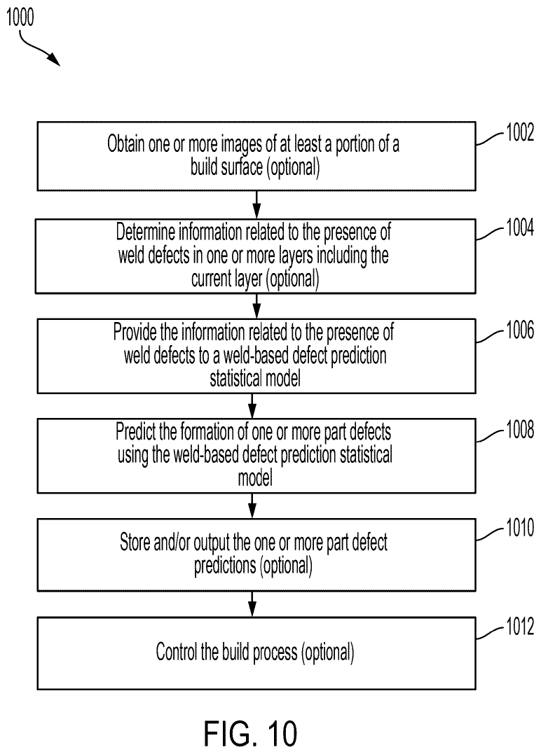

FIGS. 9 and 10 depict embodiments related to methods for training and using a trained statistical model to predict whether or not part defects are likely to be formed in one or more parts being formed during an additive manufacturing process using information related to the presence of weld defects either in the current layer and/or in one or more sequentially formed layers which may include the current layer.

In the embodiment illustrated in FIG. 9, training data may be input into a training module, such as the depicted weld-based defect detection training module 904. In some embodiments, the training data may correspond to weld quality training data 900 and part defect training data 902 as disclosed herein. As previously described, the part defect training data may be acquired from inspection of parts containing defects as well as parts not containing defects. The part defect training data may also include a location, and optionally a characterization of the part defects (e.g., a size, type, and/or severity of the part defect), associated with the identified part defects. Correspondingly, the weld quality training data may include information related to the presence of weld defects in the various build layers of the corresponding parts. As noted above, in some embodiments, the weld training data may be the weld score maps for the sequentially formed build layers of the corresponding parts. However, other outputs indicative of weld defect presence and location may also be used.

After the training data is provided to the weld-based defect detection training module, or other appropriate training module, a trained statistical model, such as a trained weld-based defect prediction statistical model, may be output from the weld-based defect detection training module at 906. Appropriate training methods may include, but are not limited to deterministic and stochastic gradient-based optimization, boosting methods, genetic algorithm, and/or any other appropriate training method. Appropriate statistical models that may be used for the weld based defect prediction statistical model include, but are not limited to, regression models, decision tree and forest based models, gaussian process, probabilistic graphical models, neural networks, and/or any other appropriate type of statistical model capable of predicting the formation of part defects using information related to the presence of weld defects.

In some embodiments, the trained weld-based defect prediction statistical model may be stored in an appropriate non-transitory processor readable memory for subsequent recall and/or use, sec 908. Depending on the particular application, the processor and associated memory used to obtain and analyze the defect data may be integrated into a single system. However, embodiments in which sensing and analysis modules are implemented on separate systems using separate processors are also contemplated.

In some embodiments, the weld-based defect prediction statistical model 906 may be continuously trained by iteratively introducing additional training data to the weld-based defect detection training module 904. Any quantity of additional parts may be selected for inspection to acquire the additional training data at any appropriate interval. For example, a predetermined number of parts may be chosen for inspection per build process. In some embodiments, the additional training may occur one or more times and may not necessarily occur at a distinct frequency. Continuously training the statistical model may continuously increase the accuracy of the weld-based defect prediction statistical model over time. For example, using weld quality score to predict part defects may become more accurate as a result of the additional training. Additionally, in some instances it may be desirable to use a statistical model that was trained for a different type of part as an initial statistical model input into the training module when training a statistical model for a new type of part with new training data. However, embodiments in which a weld-based defect prediction statistical model is only trained once and/or is trained from scratch are also contemplated.

The above noted training data may be obtained in any appropriate fashion using inspections of parts. Due to the time and cost requirements in acquiring this training data by inspection, the training data may be limited to a predetermined number of data points. Depending on the expected variations and complexity associated with a part defect to be inspected, either a larger or smaller number of data points may be needed to train the desired statistical model. For example, the number of training data points may be greater than or equal to 20 data points, 50 data points, 100 data points, 500 data points, 2,000 data points, or other appropriate number of data points. Correspondingly, the number of training data points may be less than or equal to 1,000,000 data points, 100,000 data points, 10,000 data points, 2,000 data points, 500 data points, and/or any other appropriate number of data points. Combinations of the foregoing are contemplated including, a number of training data points that is between or equal to 20 data points and 100 data points, 20 data points, and 2000 data points, and/or any other number of data points both greater than and less than the ranges noted above as the disclosure is not so limited. Additionally, any appropriate number of the collected data points may be reserved as a verification data set while the remaining data points may be used to train the desired model.

FIG. 10 is a schematic diagram of one embodiment of a method for using a weld-based defect prediction statistical model. One or more images of at least a portion of a build surface may be obtained at 1002. Information related to the presence of weld defects in the one or more layers the images correspond to may then be determined at 1004. For instance, a weld quality score map similar to that described above may be generated or otherwise obtained. Of course, other information related to the location and optionally a characterization of the part defects (e.g., a size, type, and/or severity of the part defect) may be provided. The information may either be associated with the current build layer, or optionally, the information may also include information related to one or more prior build layers. In either case, the information related to the presence of weld defects may be provided to a weld-based defect prediction statistical model at 1006. The weld-based defect prediction statistical model may then predict the formation of one or more weld defects in the current build layer at 1008. The output from the weld-based defect prediction statistical model may include a location, and optionally a characterization of the part defects (e.g., a size, type, and/or severity of the part defect), associated with the current build layer (e.g., in the current build layer or an adjacent build layer). When part defects are predicted the one or more part defect predictions may either be output to a user (e.g., the occurrence of one or more predicted part defects, location, severity, type, and/or other appropriate information) or stored in non-transitory computer readable memory at 1010. Alternatively, one or more actions may be taken to control the build process based at least in part on the part defect predictions at 1012 and as elaborated on further below.

Depending on the number, location, severity, and/or other appropriate characterization of the predicted part defects in a current build layer, different actions may be taken to control one or more aspects of a build process. In some cases, one or more minor part defects may be predicted, and the part may still be predicted to be within acceptable standards, in which case no action may be taken. For example, a part that is predicted to contain a part defect that is unlikely to result in significant structural and/or aesthetic changes may be considered non-defective, and a build process may continue without change or interruption. However, a part that is predicted to contain one or more part defects that are likely to result in significant structural and/or aesthetic changes may be considered low-quality and defective. Depending on the severity and location of the predicted part defect, as well as a likelihood of repairing the part defect, a build process of a particular part a predicted defect is associated with may be discontinued, a repair procedure may be undertaken (e.g., rewelding of the identified defect), one or more process parameters may be changed, manual intervention may be requested of a user, and/or any other appropriate action relative to the build process may be taken.

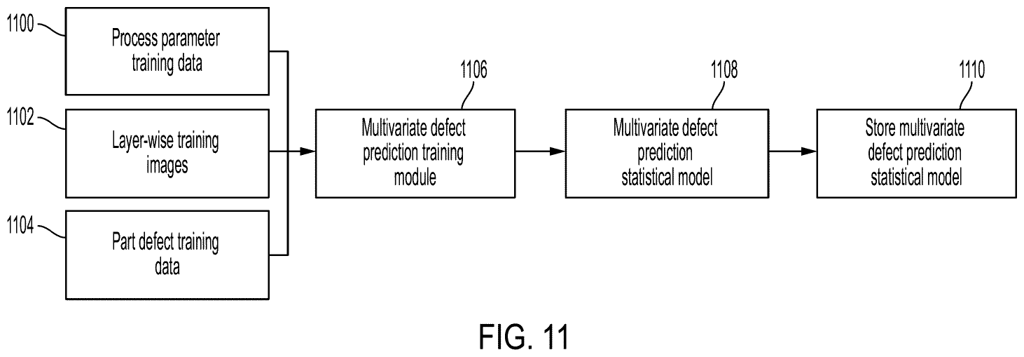

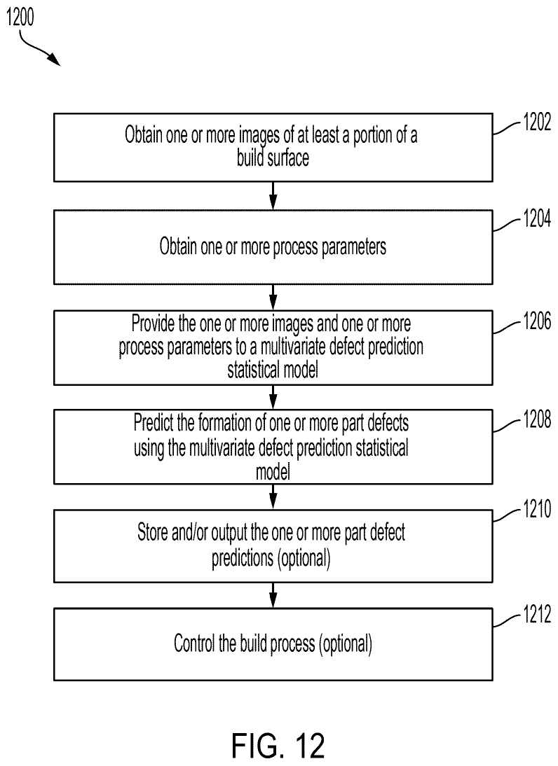

In some additive manufacturing systems, process parameters may affect the quality of welds and subsequently affect the quality of parts. These process parameters may drift over time for various reasons. Given that process parameters may change over time, it may be difficult to directly determine how changing process parameters may affect formation of part defects during a build process. Additionally, while the above method for part defect prediction is useful, the Inventors have also recognized that it may be desirable to predict part defects using images rather than information related to weld defects. However, given the complexity of predicting part defects based on process parameters and images, a large set of training data may be needed. However, the ability to generate training data from physical inspection of parts and associating that part defect training data with the corresponding images and process parameters may be difficult. Accordingly, in some embodiments, the above disclosed weld defect prediction statistical model may be used as a source of training data for part defects contained in a part as this model may be used to obtain information related to every part being built on an additive manufacturing system in a rapid easy fashion. As detailed further below, FIGS. 11 and 12 depict embodiments related to methods for training and using statistical models that use process parameters as well as associated sequential layer wise images and part defect information for training and using a statistical model for use with additive manufacturing systems.

In the embodiment illustrated in FIG. 11, training data and a statistical model may be input into a training module, such as the depicted multivariate defect detection training module 1106. In some embodiments, the training data may include process parameter training data 1100 and layer-wise training images 1102, and part defect training data 1104.

The layer-wise training images 1102 may include a plurality of sequential images for each part included in the training data. The images may be images of the different build layers used to form the part after welding where at least a portion of the layer of precursor material has been fused to form a layer of the part. The images may either be imaged by a photosensitive detector associated with an additive manufacturing system, recalled from associated memory, or obtained in any other appropriate fashion.

The process parameter training data 1104 may include any one or more appropriate types of process parameters including, but not limited to, one or more of temperature, scanning speed of the laser pixels relative to the build surface, orientation of the build surface, laser power, total energy per unit area, laser pixel size, air flow, air flow speed, weld spacing, combinations of the foregoing and/or any other appropriate parameter. The process parameters may either be a commanded parameter and/or the parameter may be sensed by an appropriate sensor (e.g., a temperature sensor, encoder, accelerometer, distance sensor, photosensitive detector, pressure sensor, air flow sensor, and/or any other appropriate type of sensor configured to detect information related to a process parameter). In either case, the process parameters may be correlated with the images of a particular part. Again, the process parameters may be directly measured, recalled from memory, or otherwise obtained in any other appropriate manner for use with the training module.

As noted above, in some embodiments, the part defect training data 1104 may be obtained using a part defect prediction model, such as the trained weld-based defect prediction statistical model described herein. In such an embodiment, the training data may be obtained by performing the above-described method to predict the formation of part defects in a part using information related to weld defects included in the various built layers as described previously. The occurrence and location of part defects in a part, as well as portions of a part not corresponding to a part defect, may be correlated with the process parameters and plurality of images for each part. Of course, embodiments in which part defect locations, and optionally a characterization of the part defects (e.g., a size, type, and/or severity of the part defect), may be obtained in any other appropriate fashion including, for example, direct inspection of the parts as previously described. Similar to the above, the part defect training data may either be directly measured in input into the module, recalled from memory, and/or otherwise obtained for use with the training module.

As noted above, after the correlated training data for each part included in the training set has been obtained, the training data may be input to the multivariate defect detection training module at 1106. After the training data and the model are provided to the multivariate defect detection training module, or other appropriate training module, a trained statistical model, such as a trained multivariate defect prediction statistical model, may be output from the multivariate defect detection training module at 1108. Appropriate training methods may include, but are not limited to deterministic and stochastic gradient-based optimization, boosting methods, genetic algorithm, and/or any other appropriate training method. Appropriate multivariate statistical models that may be used for the multivariate defect prediction statistical model include, but are not limited to, regression models, decision tree and forest based models, gaussian process, probabilistic graphical models (e.g., Bayesian networks), neural networks (e.g., convolutional neural networks, transformers), and/or any other appropriate type of statistical model capable of predicting the formation of part defects using one or more sequential images of the build layers of a part and one or more associated process parameters.

After training, the multivariate defect prediction statistical model may be stored in an appropriate non-transitory processor readable memory for subsequent recall and/or use, see 1110. Depending on the particular application, the processor and associated memory used to obtain and analyze the process parameter training data, training images, and part defect training data may be integrated into a single system. However, embodiments in which sensing and analysis modules are implemented on separate systems using separate processors are also contemplated.

In some embodiments, the multivariate defect prediction statistical model 1108 may be continuously trained by iteratively introducing additional training data to the multivariate defect detection training module 1106. Any quantity of additional sets of process parameter data and parts may be selected for inspection to acquire the additional training data at any appropriate frequency. Given that in some embodiments a part defect prediction model is used to provide the training data, this may be easily done for any number of parts produced by an additive manufacturing system. Of course, physical inspection of parts may also be done. In some embodiments, the additional training may be used one or more times and may not necessarily occur at a distinct frequency. Continuously training the statistical model may continuously increase the accuracy of the weld-based defect prediction statistical model over time. For example, using images and process parameters to predict part defect formation in a current layer may become more accurate as a result of the additional training. Additionally, in some instances it may be desirable to use a statistical model that was trained for a different type of part as an initial statistical model input into the training module when training a statistical model for a new type of part with new training data. However, embodiments in which a weld-based defect prediction statistical model is only trained once and/or is trained from scratch are also contemplated.

The above noted training data may be obtained in any appropriate fashion as described above. As the training data is related to parts being made on an additive manufacturing system, the training data may be limited to a predetermined number of data points, that is, sets of process parameter data, associated layer-wise images, and information related to either actual or predicted part defects. Depending on the expected variations and complexity associated with a part defect to be predicted, either a larger or smaller number of data points may be needed to train the desired statistical model. For example, the number of training data points may be greater than or equal to 20 data points, 50 data points, 100 data points, 500 data points, or other appropriate number of data points. Correspondingly, the number of training data points may be less than or equal to 10,000,000 data points, 1,000,000 data points, 100,000 data points, 20,000 data points, 5000 data points, 500 data points, and/or any other appropriate number of data points. Combinations of the foregoing are contemplated including, a number of training data points that is between or equal to 20 data points and 100 data points, 20 data points, and 2000 data points, and/or any other number of data points both greater than and less than the ranges noted above as the disclosure is not so limited. Additionally, any appropriate number of the collected data points may be reserved as a verification data set while the remaining data points may be used to train the desired model.

FIG. 12 is a schematic diagram of one embodiment of a method 1200 for using a multivariate defect prediction statistical model. One or more images of a build surface and one or more process parameters may be obtained at 1202 and 1204. The one or more images may correspond to one or more images of a portion of a desired build layer in which one or more portions of the build surface have been fused to form a layer of one or more parts contained in the build surface. In some embodiments, the one or more images may be images of a plurality of sequential build layers including the current build layer. The images may either be directly imaged by a photosensitive detector of an additive manufacturing system, recalled from memory, or otherwise obtained in any appropriate fashion. Similarly, the one or more process parameters associated with the build layer may either be a commanded process parameter, measured by an appropriate sensor, recalled from memory, or otherwise obtained in any appropriate fashion.

After obtaining the desired one or more process parameters and one or more images of the build surface, this data may be provided to a multivariate defect prediction statistical model at 1206. The one or more images and process data may then be used at least in part to predict the formation of one or more part defects in the one or more parts being formed in the build surface. For example, the output from the weld-based defect prediction statistical model may include a location, and optionally, a severity and/or type of predicted part defects associated with the current build layer (e.g., in the current build layer or an adjacent build layer). When part defects are predicted the one or more part defect predictions may either be output to a user (e.g., the occurrence of one or more predicted part defects, location, severity, type, and/or other appropriate information) or stored in non-transitory computer readable memory at 1210. Alternatively, one or more actions may be taken to control the build process based at least in part on the part defect predictions at 1212. Appropriate types of actions for controlling the build process based on predicted part defects may be similar to those described above relative to FIG. 10 though other appropriate actions for controlling the build process may also be taken as the disclosure is not so limited.

The various methods disclosed above may be implemented by one or more controllers including at least one processor operatively coupled to the various controllable portions of an additive manufacturing system as disclosed herein. Alternatively or additionally, in some embodiments, the disclosed methods may be performed at least in part, and in some instances completely, on a computing device that is separate and removed from the disclosed additive manufacturing systems. In either case, the disclosed methods may be embodied as computer readable instructions stored on non-transitory computer readable memory associated with the at least one processor such that when executed by the at least one processor the associated system, which may be an additive manufacturing system in some embodiments, may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

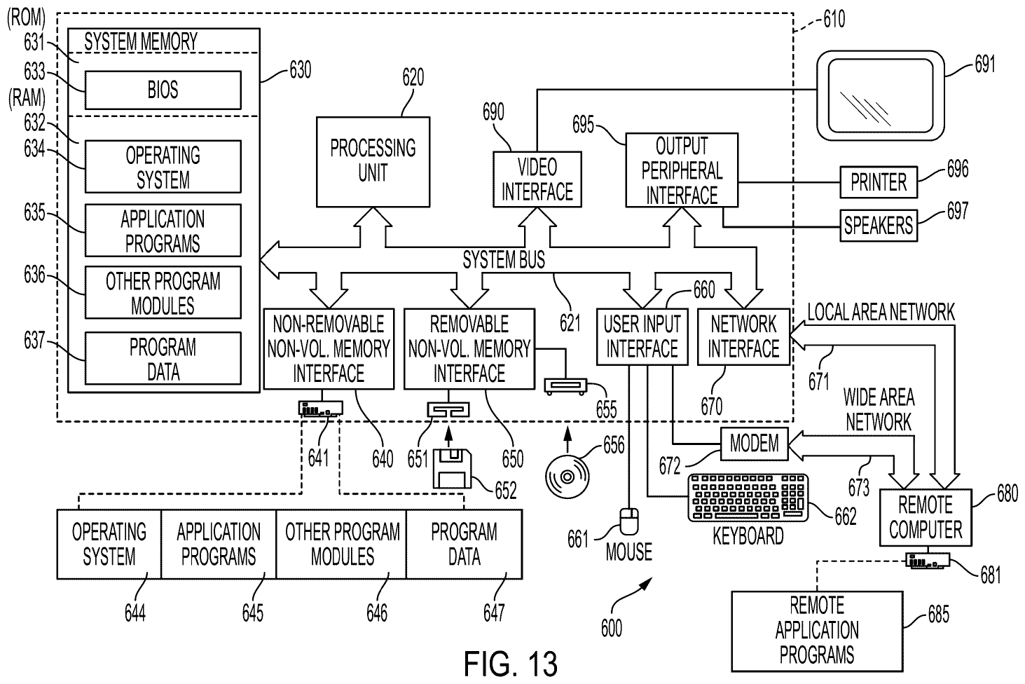

With reference to FIG. 13, an exemplary system for implementing aspects of the disclosure includes a general purpose computing device in the form of a computer 610 or other appropriate computing device. For example, the depicted computing device may be used as a soil measurement planning system configured to implement any of the methods disclosed herein. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 13 illustrates operating system 634, application programs 635, other program modules 636, and program data 637.

The computer 610 may also include other removable/non-removable, volatile/nonvolatile computer storage media. By way of example only, FIG. 13 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through an non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 13, provide storage of computer readable instructions, data structures, program modules and other data for the computer 610. In FIG. 13, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through a output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 13. The logical connections depicted in FIG. 13 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 13 illustrates remote application programs 685 as residing on memory device 681. It will be appreciated that the network connections shown are exemplary and other means of establishing a communications link between the computers may be used.

The various methods or processes outlined herein may be implemented in any suitable hardware. Additionally, the various methods or processes outlined herein may be implemented in a combination of hardware and of software executable on one or more processors that employ any one of a variety of operating systems or platforms. Examples of such approaches are described above. However, any suitable combination of hardware and software may be employed to realize any of the embodiments discussed herein.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present disclosure. The non-transitory computer-readable medium or media may be transportable, such that the program or programs stored thereon may be loaded onto any computer resource to implement various aspects of the present disclosure as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion among different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An additive manufacturing system comprising:
a build surface;
one or more laser energy sources;
an optics assembly configured to direct laser energy from the one or more laser energy sources toward the build surface to melt at least a portion of a layer of material disposed on the build surface to form one or more welds;
one or more light sources configured to illuminate the build surface, wherein the one or more light sources are configured to emit light in a direction that is at least partially parallel to the build surface;
a photosensitive detector configured to image at least a portion of the build surface; and
a processor configured to perform the steps of:
imaging at least a portion of the build surface with the photosensitive detector;
subdividing at least a portion of the image corresponding to the location of at least one part in the build surface into a plurality of regions; and
identifying the presence of weld defects in the build surface based at least in part on light intensities of the plurality of regions.

2. The additive manufacturing system of claim 1, wherein identifying the presence of the weld defects includes identifying the presence of the weld defects based at least in part on light intensities gradients in the plurality of regions.

3. The additive manufacturing system of claim 2, wherein identifying the presence of the weld defects includes identifying the presence of the weld defects based at least in part on a proportion of the light intensity gradients that are perpendicular to a local fusion direction in each region of the plurality of regions.

4. The additive manufacturing system of claim 1, wherein identifying the presence of the weld defects includes using a Gabor filter.

5. The additive manufacturing system of claim 4, wherein the Gabor filter applied to each separate region of the plurality of regions is associated with a local fusion direction of each separate region.

6. The additive manufacturing system of any claim 1, wherein identifying the presence of the weld defects includes identifying weld defects adjacent to one or more regions of the plurality of regions.

7. The additive manufacturing system of claim 1, wherein identifying the presence of the weld defects includes generating a score map associated with the plurality of regions, wherein scores associated with the plurality of regions are indicative of weld quality in the plurality of regions.

8. The additive manufacturing system of claim 7, wherein identifying the presence of the weld defects includes comparing the scores to a threshold to identify the presence of the weld defects.

9. The additive manufacturing system of claim 1, wherein the processor is configured to control at least one process of the additive manufacturing system based at least in part on the identification of the presence of weld defects.

10. The additive manufacturing system of claim 9, wherein the processor is configured to selectively stop a build process for one or more of the at least one parts based at least in part on the identification of the presence of weld defects.

11. The additive manufacturing system of claim 9, wherein the processor is configured to change one or more process parameters based at least in part on the identification of the presence of the weld defects.

12. The additive manufacturing system of claim 1, wherein the optics assembly is configured to move relative to the build surface.

13. The additive manufacturing system of claim 1, wherein the photosensitive detector is configured to move relative to the build surface.

14. The additive manufacturing system of claim 1, wherein the processor is configured to output information related to the identification of the presence of the weld defects to a user.

15. A method of detecting weld defects in a build surface of an additive manufacturing system, the method comprising:
obtaining an image of at least a portion of the build surface;
subdividing at least a portion of the image corresponding to a location of a part in the build surface into a plurality of regions; and
identifying the presence of weld defects in the build surface based at least in part on light intensities of the plurality of regions.

16. The method of claim 15, wherein identifying the presence of the weld defects includes identifying the presence of the weld defects based at least in part on light intensities gradients in the plurality of regions.

17. The method of claim 16, wherein identifying the presence of the weld defects includes identifying the presence of the weld defects based at least in part on a proportion of the light intensity gradients that are perpendicular to a local fusion direction in each region of the plurality of regions.

18. The method of claim 15, wherein identifying the presence of the weld defects includes using a Gabor filter.

19. The method of claim 18, wherein the Gabor filter applied to each separate region of the plurality of regions is associated with a local fusion direction of each separate region.

20. The method of claim 15, wherein identifying the presence of the weld defects includes identifying weld defects adjacent to one or more regions of the plurality of regions.

21. The method of claim 15, wherein identifying the presence of the weld defects includes generating a score map associated with the plurality of regions, wherein scores associated with the plurality of regions are indicative of weld quality in the plurality of regions.

22. The method of claim 21, wherein identifying the presence of the weld defects includes comparing the scores to a threshold to identify the presence of the weld defects.

23. The method of claim 15, further comprising controlling at least one process of the additive manufacturing system based at least in part on the identification of the presence of weld defects.

24. The method of claim 23, further comprising selectively stopping a build process for one or more of the at least one parts based at least in part on the identification of the presence of weld defects.

25. The method of claim 23, further comprising changing one or more process parameters based at least in part on the identification of the presence of the weld defects.

26. The method of claim 15, further comprising moving an optics assembly relative to the build surface.

27. The method of claim 15, further comprising moving a photosensitive detector relative to the build surface.

28. The method of claim 15, further comprising outputting information related to the identification of the presence of the weld defects to a user.

29. The method of claim 15, further comprising fusing precursor material on the build surface with one or more laser energy pixels to form one or more parts on the build surface.

30. A non-transitory computer readable medium including processor executable instructions that when executed by a processor perform the method of claim 15.

31. A part manufactured using the method of claim 15.

32. An additive manufacturing system comprising:
a build surface;
one or more laser energy sources;
an optics assembly configured to direct laser energy from the one or more laser energy sources toward the build surface to melt at least a portion of a layer of material disposed on the build surface to form one or more welds;
a photosensitive detector configured to image at least a portion of the build surface; and
a processor configured to perform the steps of:
providing information related to the presence of weld defects in one or more sequential layers of one or more parts to a trained weld-based defect prediction statistical model; and
predicting formation of part defects in the one or more parts using the trained weld-based defect prediction statistical model.

33-44. (canceled)

45. A method of predicting formation of part defects in one or more parts formed with an additive manufacturing system, the method comprising:
providing information related to the presence of weld defects in one or more sequential layers of the one or more parts to a trained weld-based defect prediction statistical model; and
predicting the presence of part defects in the one or more parts using the trained weld-based defect prediction statistical model.

46-59. (canceled)

60. A method for training a weld-based defect prediction statistical model, the method comprising:
obtaining training data, wherein the training data includes weld defect data and part defect data associated with a plurality of sequential layers of a plurality of separate parts formed with an additive manufacturing system;
generating a trained weld-based defect prediction statistical model using the training data; and
storing the trained statistical model on non-transitory computer readable memory for subsequent use.

61-68. (canceled)

69. An additive manufacturing system comprising:
a build surface;
one or more laser energy sources;
an optics assembly configured to direct laser energy from the one or more laser energy sources toward the build surface to melt at least a portion of a layer of material disposed on the build surface to form one or more welds;
a photosensitive detector configured to image at least a portion of the build surface; and
a processor configured to perform the steps of:
obtaining one or more images of the build surface with the photosensitive detector after fusing the material in one or more sequential layers during formation of one or more parts;
obtaining one or more process parameters associated with formation of the one or more sequential layers;
providing the one or more images and the one or more process parameters to a trained multivariate defect prediction statistical model; and
predicting the formation of part defects in the one or more parts using the trained multivariate defect prediction statistical model.

70-78. (canceled)

79. A method of predicting formation of part defects in one or more parts formed with an additive manufacturing system, the method comprising:
obtaining one or more images of a build surface after fusing material in one or more sequential layers during formation of the one or more parts;
obtaining one or more process parameters associated with formation of the one or more sequential layers of the one or more parts;
providing the one or more images and the one or more process parameters to a trained multivariate defect prediction statistical model; and
predicting the formation of part defects in the one or more parts using the trained multivariate defect prediction statistical model.

80-92. (canceled)

93. A method for training a multivariate defect prediction statistical model, the method comprising:
obtaining training data, wherein the training data includes predicted part defect data determined based at least in part on weld quality for a plurality of parts, process parameter data associated with formation of a plurality of sequential layers of the plurality of parts, and images of a build surface of an additive manufacturing system after fusing material of the plurality of sequential layers for the plurality of parts,
generating a trained multivariate statistical model using the training data; and
storing the trained multivariate statistical model on non-transitory computer readable memory for subsequent use.

94-103. (canceled)
